(19) United States
(12) Patent Application Publication
(10) Pub. No.: US 2025/0033365 A1
(43) Pub. Date: Jan. 30, 2025

(54) PRINTING APPARATUS AND TANK

(71) Applicant: CANON KABUSHIKI KAISHA, Tokyo (JP)

(72) Inventors: NORIO SAKURAI, Tokyo (JP); TSUYOSHI SAEKI, Kanagawa (JP); TAIJI MARUYAMA, Kanagawa (JP); HIROMASA TSUTSUMI, Kanagawa (JP); YUSUKE NARATANI, Tokyo (JP); SHOTA ASADA, Tokyo (JP); HIDEAKI MATSUMURA, Tokyo (JP)

(21) Appl. No.: 18/778,949

(22) Filed: Jul. 20, 2024

(30) Foreign Application Priority Data
Jul. 28, 2023 (JP) 2023-123121

(51) Int. Cl. B41J 2/175

(52) U.S. Cl. CPC B41J 2/17523

(57) ABSTRACT

Provided is a printing apparatus, including: multiple tanks that are arrayed in a first direction and store a liquid, in which a first tank, which is one of the multiple tanks, includes a first regulation portion that regulates movement of a second tank, which is out of other tanks and is not adjacent to the first tank.

### BACKGROUND OF THE INVENTION

### Field of the Invention

The present disclosure relates to a printing apparatus and a tank and specifically relates to a technique of fixing multiple tanks to the printing apparatus.

### Description of the Related Art

As a technique of integrally fixing multiple ink tanks to an ink jet printing apparatus, Japanese Patent Laid-Open No. 2012-51306 (hereinafter, referred to as PTL 1) discloses that multiple ink tanks are integrally coupled to each other in advance, and the coupled ink tanks are mounted and fixed to a printing apparatus.

However, in PTL 1, the number of times of a work to couple the ink tanks for manufacturing is the number corresponding to the number of the ink tanks. That is, in a case where the number of the ink tanks is N, the N−1 times of the coupling work is required. Accordingly, as the number of the ink tanks is increased, the number of times of the coupling work is increased, and a work to fix an ink tank unit, which is obtained by completing the coupling, to a mounting portion of the apparatus is required additionally.

### SUMMARY OF THE INVENTION

A printing apparatus of the present disclosure includes multiple tanks that are arrayed in a first direction and store a liquid, in which a first tank, which is one of the multiple tanks, includes a first regulation portion that regulates movement of a second tank, which is out of other tanks and is not adjacent to the first tank.

Further features of the present invention will become apparent from the following description of exemplary embodiments with reference to the attached drawings.

### BRIEF DESCRIPTION OF THE DRAWINGS

FIG. 1 is a schematic view of an ink jet printing apparatus of the present disclosure;

FIG. 2A is a top view of an ink tank unit according to a first embodiment;

FIG. 2B is a schematic three-view drawing of the ink tank unit according to the first embodiment;

FIG. 3A is a perspective view before thermal welding of a film of an ink tank of a black ink according to the first embodiment;

FIG. 3B is a perspective view before the thermal welding of the film of the ink tank of the black ink according to the first embodiment;

FIG. 4A is a perspective view before thermal welding of a film of an ink tank of a color ink according to the first embodiment;

FIG. 4B is a perspective view before the thermal welding of the film of the ink tank of the color ink according to the first embodiment;

FIG. 5A is a perspective view before the thermal welding of the film of the ink tank of the black ink according to the first embodiment;

FIG. 5B is a perspective view of the ink tank before the thermal welding of the film of the color ink according to the first embodiment;

FIG. 6A is a perspective view of a main body case and a perspective view in which the ink tank unit is arranged in the main body case according to the first embodiment;

FIG. 6B is a perspective view of the main body case and a perspective view in which the ink tank unit is arranged in the main body case according to the first embodiment;

FIG. 7A is a perspective view in which the ink tank unit is arranged in the main body case according to the first embodiment;

FIG. 7B is a cross-sectional view in which the ink tank unit is arranged in the main body case according to the first embodiment;

FIG. 8A is a schematic view of an ink tank unit according to a second embodiment and a third embodiment;

FIG. 8B is a schematic view of the ink tank unit according to the second embodiment and the third embodiment; and

FIG. 8C is a schematic view of the ink tank unit according to the second embodiment and the third embodiment.

### DESCRIPTION OF THE EMBODIMENTS

Embodiments of the present disclosure are described below in detail with reference to the drawings.

### First Embodiment

### (Ink Jet Printing Apparatus Overview)

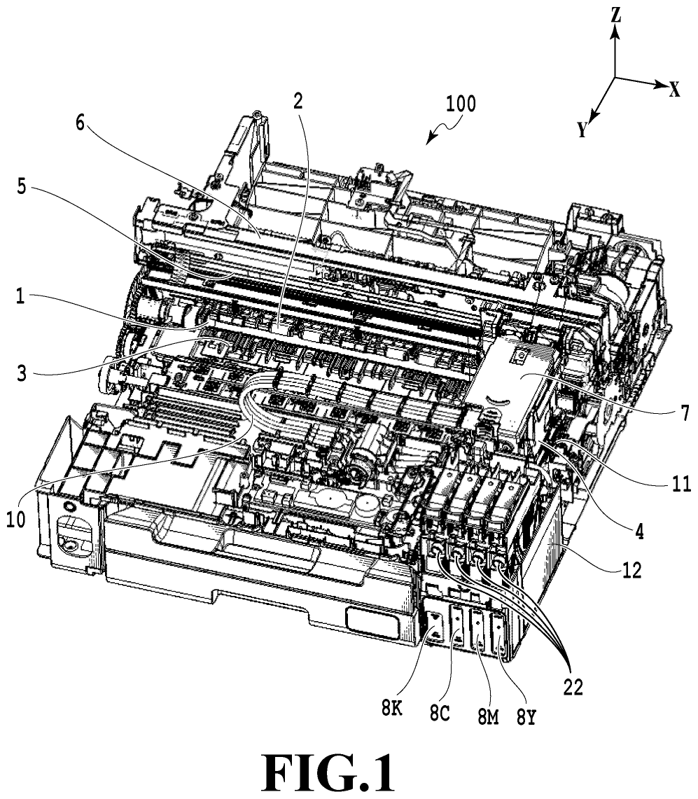

FIG. 1 illustrates a schematic view of an ink jet printing apparatus (hereinafter, also referred to as a printing apparatus) according to a first embodiment. An ink jet printing apparatus 100 includes a conveyance roller 1, a pinch roller 2, a platen 3, a printing head 4, guide rails 5 and 6, a carriage 7, an ink tank 8 (8K, 8C, 8M, and 8Y), a tube 10, a recovery unit 11, and a main body case 12 (a support).

During printing, a printing medium is supplied by a feed roller (not illustrated). The printing medium is pinched by the conveyance roller 1 and the pinch roller 2 and conveyed in a Y direction by rotation of the conveyance roller 1 while being guided and supported by the platen 3. A surface of the conveyance roller 1 has fine irregularities so as to increase frictional force. The pinch roller 2 is elastically biased to the conveyance roller 1 by a pressing unit such as a spring. The platen 3 supports the printing medium and maintains a distance between a surface of the printing medium and an ink ejection surface of the printing head 4 at a predetermined distance.

The carriage 7 is reciprocally moved by a driving unit such as a motor in an X direction along the guide rails 5 and 6 arranged above and below the carriage 7. The X direction in which the carriage 7 is moved is called a main scanning direction, and the Y direction in which the printing medium is conveyed is called a sub scanning direction.

The printing head 4 is detachably mounted on the carriage 7 and arranged to face the printing medium. The printing head 4 includes multiple nozzle rows to eject different colors of inks (liquids), respectively. As an energy system for ink ejection, the printing head 4 can use a thermal energy system including a unit that generates a thermal energy (for example, a heating resistance element) to change a state of the ink (film boiling) or a vibration energy system.

The multiple ink tanks 8 (8K, 8C, 8M, and 8Y) are arranged and fixed to the main body case 12. In the present embodiment, the multiple ink tanks 8 are arrayed in the main scanning direction (the X direction). The multiple ink tanks 8 (8K, 8C, 8M, and 8Y) correspond to the ink colors (black, cyan, magenta, and yellow) that can be ejected by the printing head 4. The ink tank 8K stores the black ink, the ink tank 8C stores the cyan ink, the ink tank 8M stores the magenta ink, and the ink tank 8Y stores the yellow ink.

Each ink tank 8 and the printing head 4 are connected to each other by the tube 10 for each ink color. The ink in each ink tank 8 is supplied to the corresponding nozzle row in the printing head 4 via the tube 10. Note that, the arrayed direction of the multiple ink tanks 8 is not limited to a direction orthogonal to the conveyance direction of the printing medium. In the present embodiment, the ink tanks 8C, 8M, and 8Y are formed by using common parts; however, the ink tanks 8C, 8M, and 8Y may be formed by different parts.

The recovery unit 11 includes a cap portion to cap the ink ejection surface of the printing head 4, a suction mechanism to suck the ink from the printing head 4 while the ink ejection surface is being capped, a cleaning blade to wipe out the dirt on the ink ejection surface, and the like. The recovery unit 11 is arranged in a non-printing region, which is a region within a range of the reciprocal movement of the printing head 4 but outside a passing range of the conveyed printing medium. The recovery unit 11 is arranged in a position in which the recovery unit 11 can face the ink ejection surface of the printing head 4.

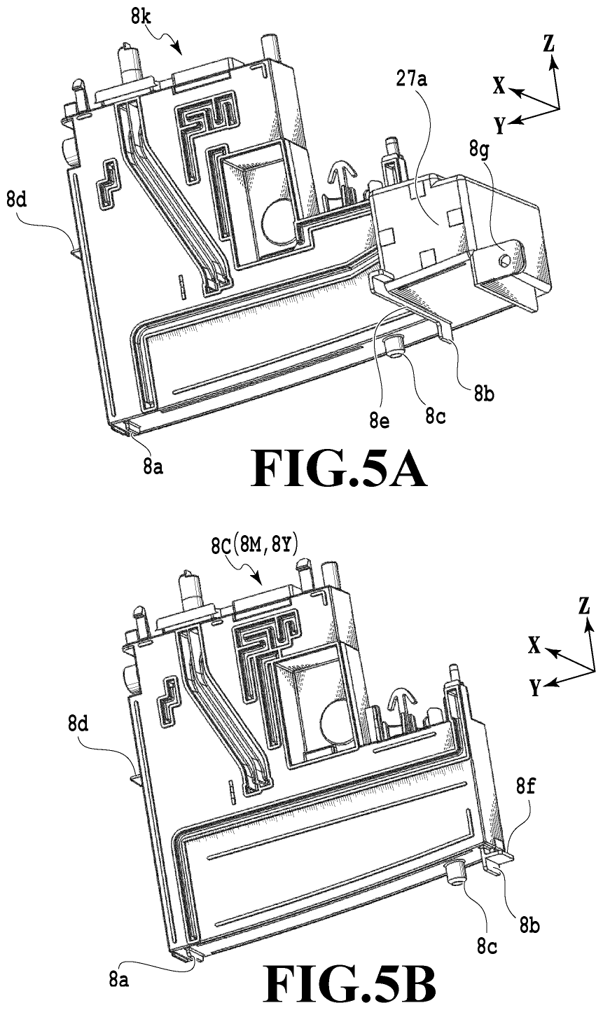

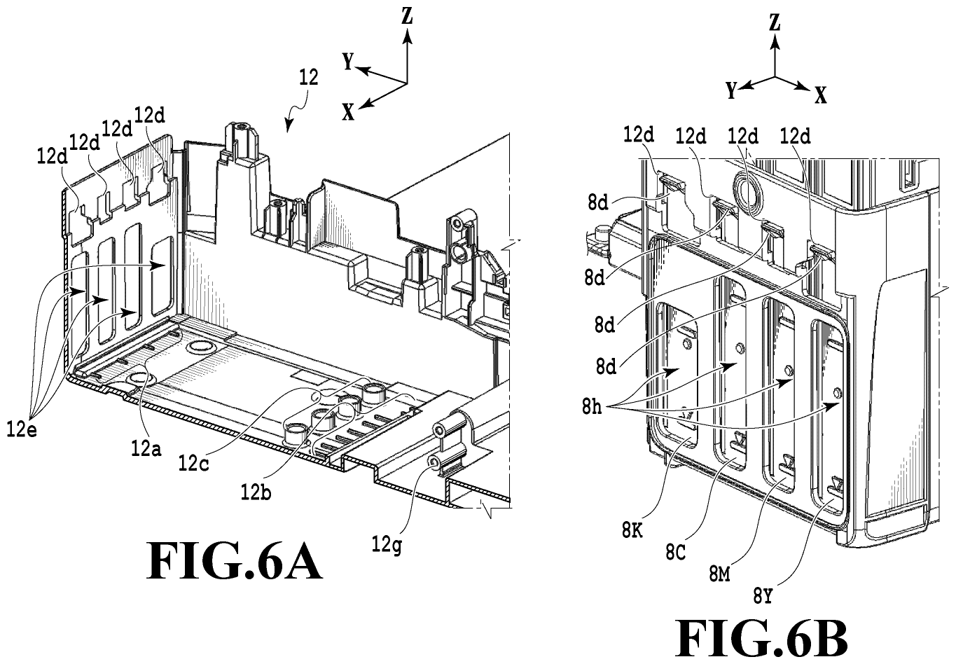

The multiple ink tanks 8 (8K, 8C, 8M, and 8Y) are arranged in the main body case 12. In the present embodiment, one ink tank (for example, 8K) is directly fixed to the main body case 12 while the other ink tanks 8C, 8M, and 8Y are not directly fixed to the main body case 12. Details of the structure regarding the fixing are described later with reference to FIGS. 5, 6, and the like.

After the printing on the printing medium by the printing head 4 is performed, the printing medium is pinched by a discharge roller and a spur (not illustrated) that is a rotating body and discharged from the printing apparatus 100 by rotation of the discharge roller. The discharge roller is a rubber roller having a friction coefficient. The spur is elastically biased to the discharge roller by a pressing unit such as a spring.

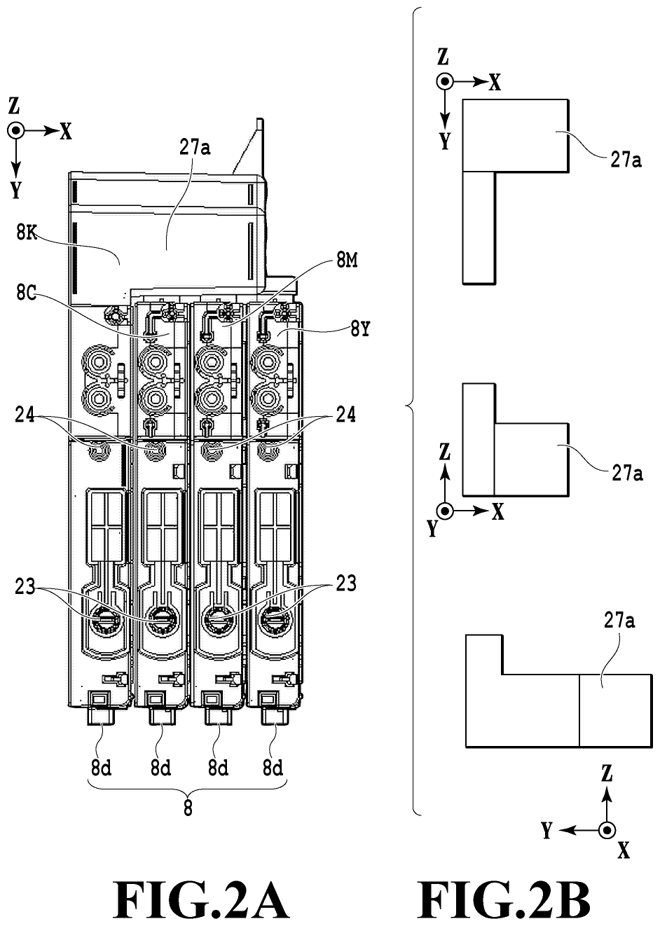

FIG. 2A illustrates the ink tank 8 (8K, 8C, 8M, and 8Y) according to the present embodiment, and FIG. 2B illustrates a schematic three-view drawing of the ink tank 8K. The ink tank 8 (8K, 8C, 8M, and 8Y) includes an ink filling port 23 to pour the ink to the inside and a tube joint 24 coupled with the tube 10. The ink filling port 23 is arranged in an upper portion of the ink tank 8, and a plug member 22 is attached to the corresponding ink filling port 23 so as to be openable and closable.

As illustrated in FIGS. 2A and 2B, the ink tank 8K includes an enlarged portion 27a. As illustrated in FIG. 2B, the enlarged portion 27a extends in the X direction, and the ink tanks 8K, 8C, 8M, and 8Y are arranged along this X direction. In the present embodiment, the ink tank 8K is arranged at an end of an ink tank unit.

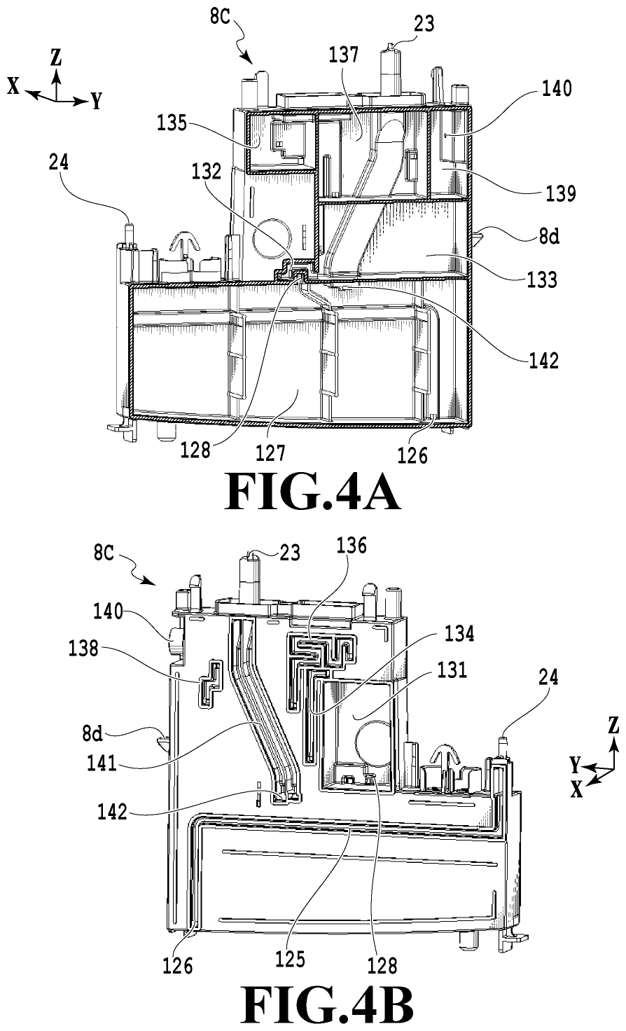

The enlarged portion 27a of the ink tank 8K and an ink storage chamber 127 of each of the ink tanks 8C, 8M, and 8Y (see FIG. 4) are overlapped with each other along the X direction. That is, in a case of viewing from the Y direction, the enlarged portion 27a and all or a part of the ink tanks 8C, 8M, and 8Y are overlapped with each other.

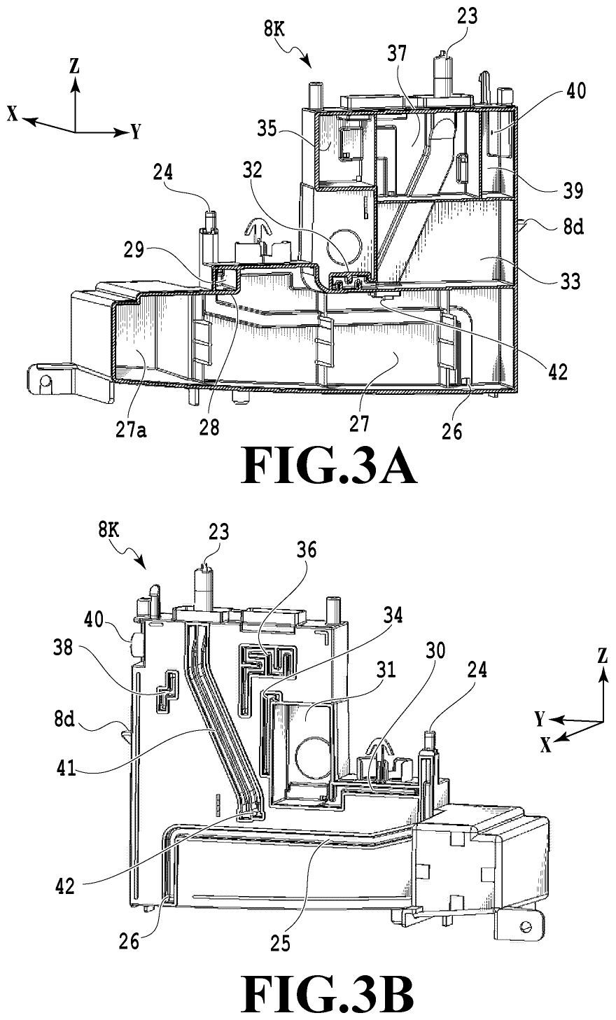

FIGS. 3A and 3B are perspective views before thermal welding of a film of the ink tank 8K according to the present embodiment. As illustrated in FIGS. 3A and 3B, the ink is poured from the ink filling port 23 and stored into an ink storage chamber 27 through a flow channel 41 and an opening 42. The enlarged portion 27a, which is a part of the ink storage chamber 27, extends in the X direction, and the ink tank 8K stores a greater capacity of the ink than that of the ink tanks 8C, 8M, and 8Y. The tube joint 24 and an opening 26 arranged in a bottom surface of the ink storage chamber 27 communicate with each other through a communication path 25.

Next, a buffer chamber configuration that is an air communication flow channel is described. The ink storage chamber 27 and a buffer chamber 29 communicate with each other through an opening 28. The buffer chamber 29 and a buffer chamber 31 communicate with each other through a flow channel 30. The buffer chamber 31 and a buffer chamber 33 communicate with each other through a flow channel 32. The buffer chamber 33 and a buffer chamber 35 communicate with each other through a flow channel 34. The buffer chamber 35 and a buffer chamber 37 communicate with each other through a flow channel 36. The buffer chamber 37 and a buffer chamber 39 communicate with each other through a flow channel 38. Additionally, the buffer chamber 39 communicates with outside air via an air communication port 40. With the above configuration, in a case where the printing apparatus 100 is tipped over, and the orientation of the ink tank 8K is changed, each buffer chamber can store the ink leaked out of the ink storage chamber 27. Therefore, leaking of the ink to the outside from the ink tank 8K is suppressed. Note that, a not-illustrated film is thermally welded on each of two surfaces of the ink tank 8K, and the ink storage chamber 27, each buffer chamber, and each flow channel are sealed.

FIG. 4A is a perspective view before thermal welding of a film of the ink tank 8C according to the present embodiment. Since the ink tanks 8C, 8M, and 8Y have a common configuration, the ink tank 8C is described in FIG. 4. As illustrated in FIGS. 4A and 4B, the ink is poured from the ink filling port 23 and stored into the ink storage chamber 127 through a flow channel 141 and an opening 142. The tube joint 24 and an opening 126 arranged in a bottom surface of the ink storage chamber 127 communicate with each other through a communication path 125.

Next, a buffer chamber configuration as an air communication flow channel is described. The ink storage chamber 127 and a buffer chamber 131 communicate with each other through an opening 128. The buffer chamber 131 and a buffer chamber 133 communicate with each other through a flow channel 132. The buffer chamber 133 and a buffer chamber 135 communicate with each other through a flow channel 134. The buffer chamber 135 and a buffer chamber 137 communicate with each other through a flow channel 136. The buffer chamber 137 and a buffer chamber 139 communicate with each other through a flow channel 138. Additionally, the buffer chamber 139 communicates with the outside air through an air communication port 140. With the above configuration, in a case where the printing apparatus 100 is tipped over, and the orientation of the ink tank 8C is changed, each buffer chamber can store the ink leaked out of the ink storage chamber 127. Therefore, leaking of the ink to the outside from the ink tank 8C is suppressed. Note that, a not-illustrated film is thermally welded on each of two surfaces of the ink tank 8C, and the ink storage chamber, each buffer chamber, and each flow channel are sealed.

In the present embodiment, the ink tank 8K can store about 70 ml of the ink, and the ink tanks 8C, 8M, and 8Y can each store about 40 ml of the ink. The capacity of the ink tank 8K is designed to be greater than the capacity of the ink tanks 8C, 8M, and 8Y because a lot of the black ink is used for printing. A ratio of the ink capacities of the ink tanks can be changed as needed. A width of the ink tank 8K in the Y direction and a width of the ink tanks 8C, 8M, and 8Y in the Y direction may be an arbitrary width.

Next, fixing and mounting of each ink tank 8 to the printing apparatus 100 are described with reference to FIGS. 5 and 6. FIG. 5A illustrates the ink tank 8K, and FIG. 5B illustrates the ink tank 8C. Since the ink tanks 8C, 8M, and 8Y have the common configuration, the ink tank 8C is described in FIG. 5B. FIG. 6A illustrates the main body case 12 before each ink tank 8 is mounted, and FIG. 6B illustrates a state where each ink tank 8 is arranged in the main body case 12.

As illustrated in FIGS. 5A and 5B, a protrusion 8a, a protrusion 8b, and a boss 8c are arranged as a third regulated portion on a bottom surface of each ink tank 8. On the other hand, as illustrated in FIG. 6A, a contact surface 12a, a contact surface 12b, and a hole 12c are arranged as a third regulation portion corresponding to the third regulated portion on the main body case 12 (the support). The protrusion 8a is engaged with the contact surface 12a, the protrusion 8b is engaged with the contact surface 12b, and the boss 8c is engaged with the hole 12c. With the engagement, movement in an XY direction (a horizontal direction) and a Z direction (a gravity direction) of each ink tank 8 is regulated. With the above-described configuration, provisional fixing to the printing apparatus 100 can be performed only by mounting each ink tank 8 on the main body case 12 from the above, and an assembling work is facilitated.

Additionally, as illustrated in FIGS. 5A and 5B, a protrusion 8d is arranged as a fourth regulated portion on a front surface (a side surface) of each ink tank 8. Corresponding to this, as illustrated in FIGS. 6A and 6B, a hole 12d is arranged as a fourth regulation portion in the main body case 12. The protrusion 8d and the hole 12d are engaged with each other and regulate the movement of the ink tank 8.

Next, as illustrated in FIG. 5A, a rib 8e is provided as a first regulation portion to a portion corresponding to the enlarged portion 27a of the ink tank 8K. Additionally, corresponding to this, a rib 8f corresponding to the rib 8e is provided as a first regulated portion to the ink tank 8C. In a case of mounting the ink tank 8 (8K, 8C, 8M, and 8Y) onto the main body case 12, the ink tank (8C, 8M, and 8Y) is mounted before the ink tank 8K. Additionally, the ink tank 8K is arranged at last and fixed to the main body case 12.

As described above, with the ink tank (8C, 8M, and 8Y) being mounted first, and the ink tank 8K being mounted at last, the rib 8e of the enlarged portion 27a is arranged above the multiple ribs 8f in the Z direction. Thus, movement of the rib 8f of each of the ink tanks 8C, 8M, and 8Y in the Z direction is regulated by the rib 8e of the ink tank 8K. With such a configuration, the first regulation portion 8e of the ink tank 8K is put in contact with the first regulated portion 8f of the adjacent ink tank 8C and the first regulated portions 8f of the non-adjacent ink tanks 8M and 8Y. Accordingly, the first regulation portion 8e of the ink tank 8K regulates upward movement of the ink tanks 8C, 8M, and 8Y in the Z direction (an opposite direction of the gravity direction).

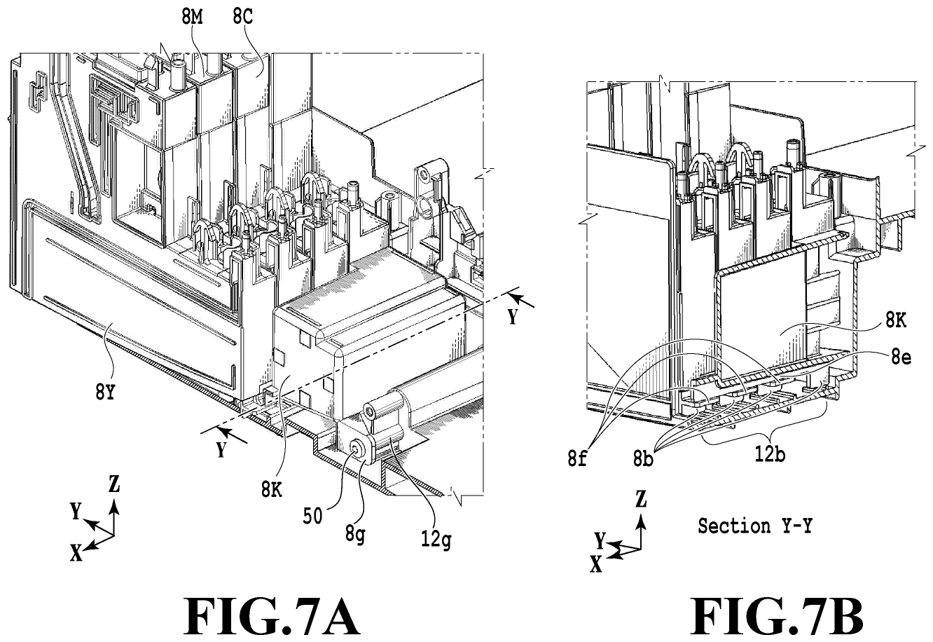

FIG. 7A illustrates the ink tank 8 (8K, 8C, 8M, and 8Y) fixed to the main body case 12 according to the present embodiment. The ink tank 8K includes a fixed portion 8g (a second regulated portion). The main body case 12 includes a fixing portion 12g (a second regulation portion) corresponding to the fixed portion 8g. The fixing portion 12g and the fixed portion 8g are fixed to each other with a screw 50; however, the fixing portion 12g and the fixed portion 8g may be fixed to each other by a snap-fit. The fixing by the screw 50 fixes the main body case 12 and the ink tank 8K solidly, and the fixing by the snap-fit facilitates the assembling work.

FIG. 7B is a perspective view of a Y-Y cross section in FIG. 7A. In FIG. 7B, the protrusion 8b of each ink tank 8 is engaged with the contact surface 12b of the main body case 12. Additionally, as mentioned above, the protrusion 8a of each ink tank 8 is engaged with the contact surface 12a of the main body case 12, and the boss 8c of each ink tank 8 is engaged with the hole 12c of the main body case 12. The rib 8e (the first regulation portion) of the ink tank 8K is put in contact with the rib 8f (the first regulated portion) of the other ink tank and regulates movement of the other ink tank in the Z direction.

With such a configuration, with the ink tank 8K being fixed to the main body case 12, the ink tank (8C, 8M, and 8Y) is also fixed to the main body case 12. Accordingly, the ink tank 8K regulates each movement of the adjacent ink tank 8C and the non-adjacent ink tank (8M and 8Y). Additionally, it is possible to separate the ink tank (8C, 8M, and 8Y) by detaching the ink tank 8K from the main body case 12, and replacement of the ink tank 8 is facilitated.

Moreover, the second regulation portion can regulate movement of the ink tank 8K in a specific direction. For example, in a case of a configuration in which only the movement in the Z direction is regulated, and no movement in other directions is regulated, it is possible to prevent occurrence of torsion between the ink tank 8 and the main body case 12.

### Second Embodiment

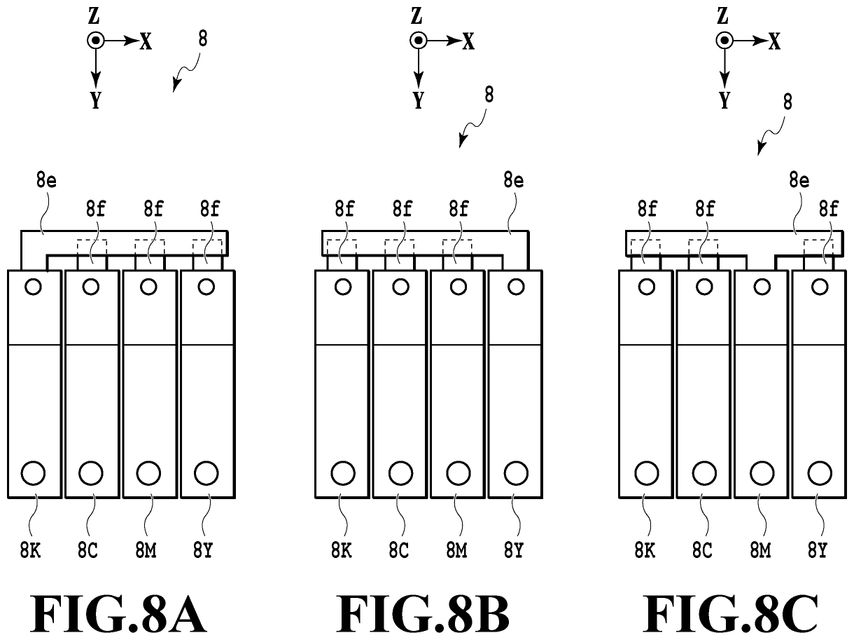

FIG. 8A illustrates the ink tank 8 (8K, 8C, 8M, and 8Y) according to the present embodiment. In a second embodiment, each ink tank 8 is arranged along the X direction. In the present embodiment, the ink tank 8K is arranged at an end of the ink tank unit. In FIG. 8A, the ink tank 8K does not include the enlarged portion 27a and includes only the first regulation portion 8e. The first regulation portion 8e is a part extending in the X direction. The first regulation portion 8e is put in contact with the first regulated portion 8f of the other ink tank and regulates each movement of the adjacent ink tank 8C and the non-adjacent ink tanks 8M and 8Y in the Z direction.

FIG. 8B illustrates the ink tank 8 (8K, 8C, 8M, and 8Y) according to another mode of the present embodiment. In FIG. 8B, the ink tank 8Y includes the first regulation portion 8e, and the ink tank 8Y is arranged at an end of the ink tank unit. The ink tanks 8K, 8C, and 8M each include the first regulated portion 8f, and the first regulation portion 8e regulates each movement of the adjacent ink tank 8M and the non-adjacent ink tanks 8K and 8C in the Z direction. With such a configuration, it is possible to form a small ink tank unit.

### Third Embodiment

FIG. 8C illustrates the ink tank 8 (8K, 8C, 8M, and 8Y) according to the present embodiment. In FIG. 8C, the ink tank 8M includes the first regulation portion 8e, and the ink tank 8M is arranged in a portion other than an end of the ink tank unit. As illustrated in FIG. 8C, the ink tank 8M includes the first regulation portion 8e, the ink tanks 8K, 8C, and 8Y each include the first regulated portion 8f, and the first regulation portion 8e regulates movement of the adjacent ink tanks 8C and 8Y and the non-adjacent ink tank 8K in the Z direction.

In the present embodiment, the first regulation portion 8e is formed so as to extend in two directions of +X direction along the direction in which the ink tanks (8K, 8C, 8M, and 8Y) are arrayed. Each regulation portion extending in corresponding one of the two directions is shorter than the first regulation portion 8e in the second embodiment; for this reason, deformation of the member is suppressed, and this further ensures the regulation of the movement of the other ink tank in the Z direction.

Note that, the first regulation portion 8e in all the above-described embodiments may be detachable.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-123121, filed Jul. 28, 2023, which is hereby incorporated by reference wherein in its entirety.

What is claimed is:

1. A printing apparatus, comprising:
a plurality of tanks that are arrayed in a first direction and store a liquid, wherein
a first tank, which is one of the plurality of tanks, includes a first regulation portion that regulates movement of a second tank, which is out of other tanks and is not adjacent to the first tank.

2. The printing apparatus according to claim 1, wherein
the first tank is arrayed at an end of the plurality of tanks in the first direction.

3. The printing apparatus according to claim 1, wherein
the first tank is arrayed in a portion other than an end of the plurality of tanks in the first direction.

4. The printing apparatus according to claim 1, wherein
the first tank includes a storage portion extending the first direction, and the first regulation portion is provided to the storage portion.

5. The printing apparatus according to claim 1, wherein
the second tank includes a first regulated portion, and
the first regulation portion regulates movement of the first regulated portion in at least an opposite direction of a gravity direction.

6. The printing apparatus according to claim 1, wherein
the printing apparatus further includes a second regulation portion,
the first tank further includes a second regulated portion, and
movement of the second regulated portion is regulated by the second regulation portion.

7. The printing apparatus according to claim 6, wherein
the second regulated portion is fixed to the second regulation portion with a screw.

8. The printing apparatus according to claim 6, wherein
the second regulated portion is fixed to the second regulation portion by a snap-fit.

9. The printing apparatus according to claim 1, wherein
the tank further includes a third regulated portion, and
the printing apparatus further includes a third regulation portion that regulates movement of the third regulated portion.

10. The printing apparatus according to claim 9, wherein
the third regulation portion regulates movement of the third regulated portion in a horizontal direction and a gravity direction.

11. The printing apparatus according to claim 9, wherein
the tank further includes a fourth regulated portion, and
the printing apparatus further includes a fourth regulation portion that regulates movement of the fourth regulated portion.

12. The printing apparatus according to claim 1, wherein
the first regulation portion is detachable from the first tank.

13. The printing apparatus according to claim 1, wherein
the first tank stores a black ink.

14. The printing apparatus according to claim 1, wherein
the first regulation portion regulates movement of a plurality of tanks including an adjacent tank.

15. A tank that stores a liquid, comprising:
a first regulated portion in which movement is regulated by a first regulation portion included in another tank arrayed in a first direction with the tank.
